(19) United States
(12) Patent Application Publication
(10) Pub. No.: US 2014/0202841 A1
(43) Pub. Date: Jul. 24, 2014

(54) PUSHBUTTON SWITCH

(71) Applicant: JUDCO PARTNERSHIP, LLC, Harbor City, CA (US)

(72) Inventor: Igorce Srbinovski, Harbor City, CA (US)

(73) Assignee: JUDCO PARTNERSHIP, LLC, Harbor City, CA (US)

(21) Appl. No.: 14/160,475

(22) Filed: Jan. 21, 2014

Related U.S. Application Data
(60) Provisional application No. 61/754,825, filed on Jan. 21, 2013.
(60) Provisional application No. 61/791,658, filed on Mar. 15, 2013.

(51) Int. Cl. H01H 13/58

(52) U.S. Cl. CPC H01H 13/58
USPC 200/526

(57) ABSTRACT

A pushbutton switch comprises a body including a barrel, a plunger longitudinally movable in the barrel, a ratchet coaxial with the plunger including a plurality of longitudinally extending camming teeth, and at least one longitudinally extending camming tooth on the plunger for engagement with the camming teeth on the ratchet, wherein the body and cover comprise a synthetic polymer material. The cover and body can comprise a glass-filled material. Further the ratchet and the plunger can comprise a polyoxymethylene (POM) plastic material.

### CROSS-REFERENCE TO RELATED APPLICATIONS

This application claims the priority benefit of U.S. Provisional Patent Application Ser. No. 61/754,825, filed Jan. 21, 2013, and U.S. Provisional Patent Application Ser. No. 61/791,658, filed Mar. 15, 2013, both are incorporated herein by reference in their entirety.

### FIELD OF THE INVENTION

The present invention is related to pushbutton switches for electrical circuits, and in particular to pushbutton switches with a ratchet mechanism.

### BACKGROUND

Pushbutton switches with a ratchet mechanism are useful in electrical circuits such as a momentary ON switch in which electrical contact is made upon advancing a plunger, and contact is broken when the plunger retracts. The ratchet mechanism is useful in other pushbutton switches and in other applications where a reciprocating motion is converted to stepwise rotary motion.

### BRIEF SUMMARY

A pushbutton switch comprises a body including a barrel, a plunger longitudinally movable in the barrel, a ratchet coaxial with the plunger including a plurality of longitudinally extending camming teeth, and at least one longitudinally extending camming tooth on the plunger for engagement with the camming teeth on the ratchet, wherein the body and cover comprise a synthetic polymer material. The cover and body can comprise a glass-filled material. Further the ratchet and the plunger can comprise a polyoxymethylene (POM) plastic material.

These and other features, aspects and advantages of the present invention will become understood with reference to the following description, appended claims and accompanying figures.

### BRIEF DESCRIPTION OF THE DRAWINGS

The embodiments are illustrated by way of example, and not by way of limitation, in the Figures of the accompanying drawings and in which like reference numerals refer to similar elements and in which:

FIG. 1 is an exploded view of an exemplary pushbutton switch, according to an embodiment.

FIGS. 2A-2E show various views of the switch body in FIG. 1.

FIGS. 2F-2J show various views of the switch cover in FIG. 1.

FIG. 3 shows a broken away and flattened portion of the interior wall of the barrel of switch of FIG. 1.

FIGS. 4A-4E show different views of the plunger of the switch of FIG. 1.

FIGS. 5A-5E show different views of the ratchet of the switch of FIG. 1.

FIGS. 6A-6E show different views of the contact cup of the switch of FIG. 1.

FIGS. 7A-7C show different views of the body and splines of the switch of FIG. 1.

FIGS. 8A-8D show different views of the switch of FIG. 1, in assembled form.

FIGS. 9A-9B show further views of the switch of FIG. 1, in assembled form.

### DESCRIPTION OF THE INVENTION

The present invention relates to a ratchet mechanism which is particularly useful in pushbutton switches for use in electrical circuits and, in particular, to pushbutton switches where it is desired that action be “soft”, both in sound and tactile feel. The ratchet mechanism is useful in other pushbutton switches and in other applications where a reciprocating motion is converted to stepwise rotary motion.

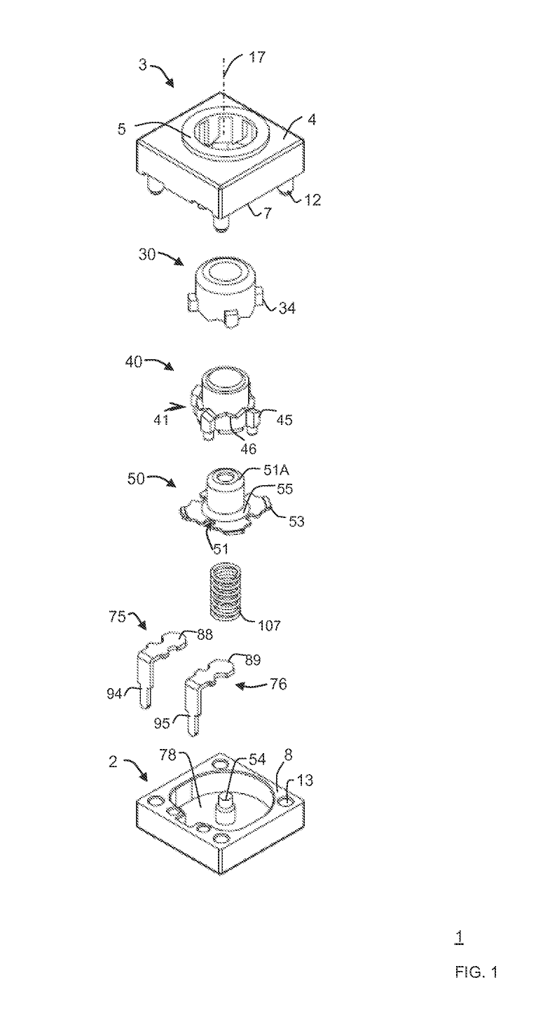

Referring to FIGS. 1-8, embodiments of a pushbutton switch disclosed herein, are described. According to an embodiment of the invention, a pushbutton has a body including a barrel and a plunger longitudinally movable in the barrel. A plurality of longitudinally extending teeth on the plunger engage a plurality of longitudinally extending teeth on a rotatable ratchet coaxial with the plunger. The ratchet is spring loaded against the plunger. A rotatable electrical contact cup connected to the ratchet makes or breaks contact with a fixed electrical terminal in the body. The plunger teeth each include a driving face which causes rotation of the ratchet.

The driving face has an angle from a normal (e.g., up to) 30° to the longitudinal direction of the plunger wherein the angle is at least the arctangent of the coefficient of friction between the ratchet teeth and the plunger tooth plus the arctangent of the effective coefficient of friction between electrical contacts in the switch, plus a margin of safety greater than the arctangent of the effective coefficient of friction between other parts of the switch. An example of determining said angle based on said arctangent of the coefficient of friction, is described generally in U.S. Pat. No. 6,621,028, incorporated herein by reference.

FIG. 1 is an exploded view of an exemplary embodiment of the ratchet in the context of a pushbutton switch 1. The switch 1 includes separable housing portions comprising a cover 2 and a body 3. A plunger 30, ratchet 40 and contact cup 50 are contained within the body.

The body has an essentially rectangular portion 4 and a barrel 5. The barrel 5 is open at its ends and may or may not have threads on its exterior surface. The portion 4 of the body 3 is provided with a mating surface 7. The mating surface 7 has a plurality of spaced pin members 12. The pin members 12 are disposed in two substantially parallel rows on opposite sides of the barrel and are engagable with recesses 13 correspondingly located in a conforming surface 8 of the cover 2.

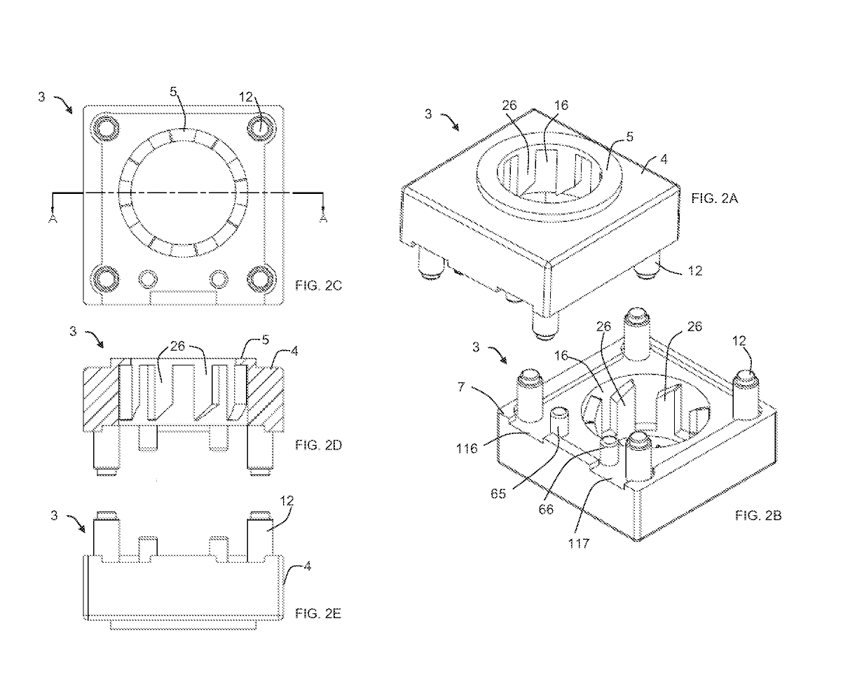

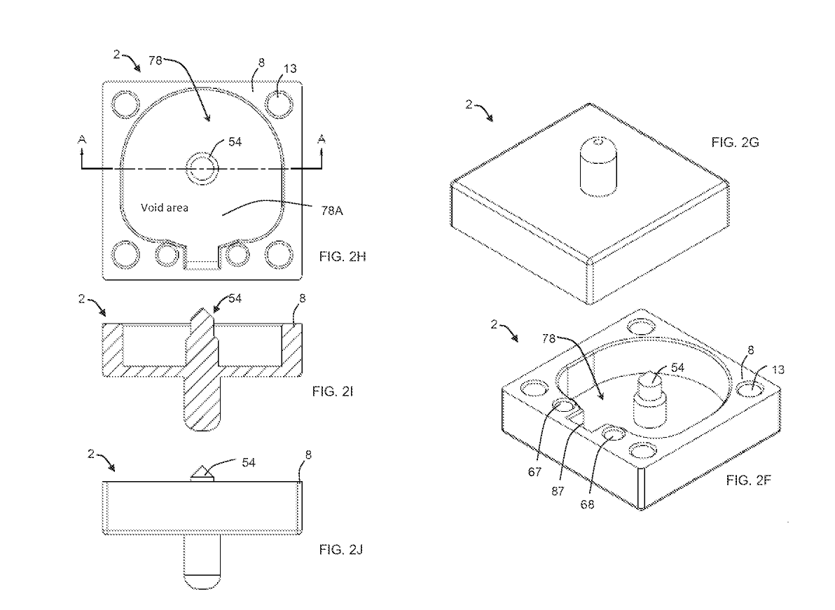

FIG. 2A shows a top perspective view of the body 3, and FIG. 2B shows a bottom perspective view of the body 3, illustrating interior wall 16 of the barrel 5, having plural splines 26. FIG. 2C shows a bottom view of the body 3, and FIG. 2D shows a cross-sectioned view of the body 3 in FIG. 2C along lines A-A. FIG. 2E shows a side view of the body 3.

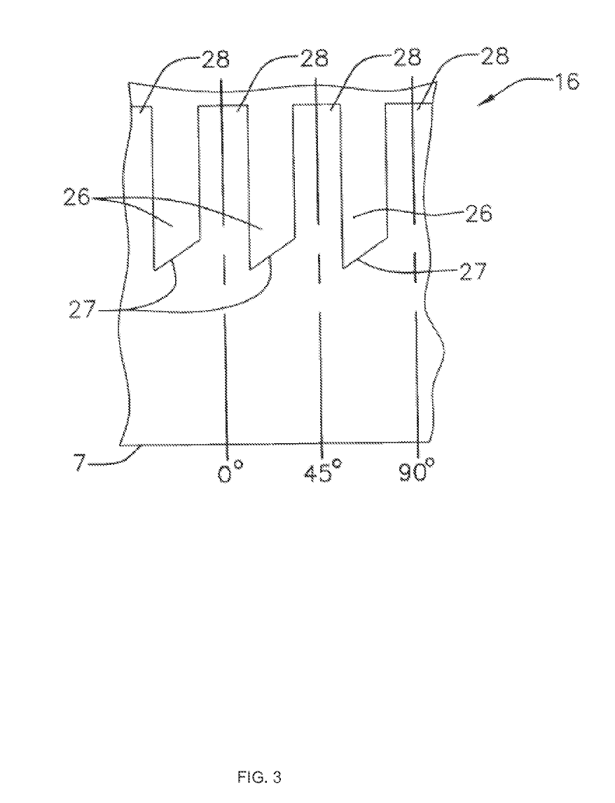

A broken away and flattened portion of the interior wall 16 of the barrel 5 is shown in FIG. 3. Splines 26 inside the barrel 5 have spaced apart parallel walls extending longitudinally parallel to the axis 17 (FIG. 1) of the barrel. Ramps 27 form the ends of the splines 26 closest to the mating surface 7. The ramps have an angle of about 55° from the sides of the splines. This increases the driving torque and allows use of a low force spring 107 (FIG. 1). In switch operation, there is a low actuation force of about 2N with a margin of about +/−0.5N (N stands for Newton as unit of force).

The splines are formed by molding the barrel to have a thicker wall in the region of the splines than in the remainder of the barrel. The thinner wall portions between adjacent splines comprise longitudinally extending ways 28. In an exemplary embodiment there are eight splines equally spaced 45° apart, hence eight ways between adjacent splines.

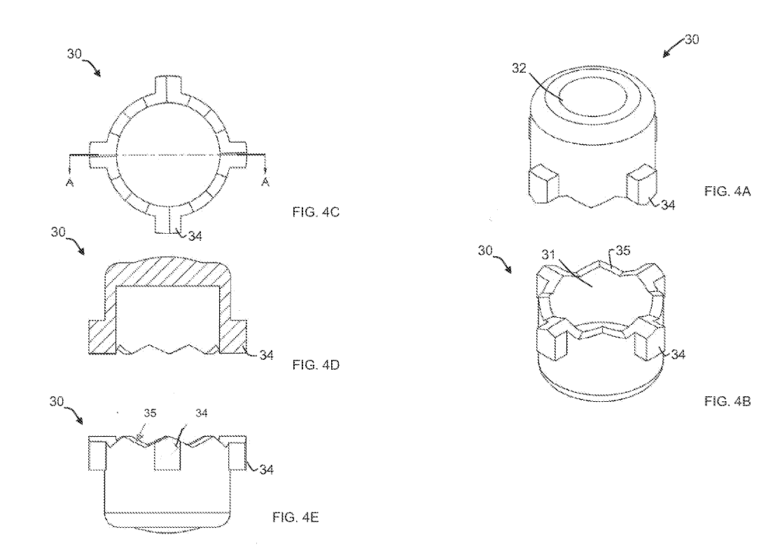

An embodiment of the plunger 30 is schematically shown in FIGS. 4A-E. Specifically, FIG. 4A shows a top perspective view of the plunger, and FIG. 4B shows a bottom perspective view of the plunger, illustrating switch elements 31, 34 and 35. FIG. 4C shows a bottom view of the plunger, and FIG. 4D shows a cross-sectioned view of the plunger in FIG. 4C along lines A-A. FIG. 4E shows a side view of the plunger.

The plunger 30 is constrained to translation, i.e., axial sliding movement within the barrel. The plunger is tubular in form, having an open end portion 31 and a closed end portion 32. When inserted in the body, the closed end portion 32 projects out of the barrel providing a primary actuating button for operation of the switch.

The open end portion 31 has a plurality of circumferentially spaced lugs 34, with four lugs being employed in this embodiment. The lugs are spaced 90° apart projecting generally radially outwardly. When the plunger is within the barrel, the lugs ride in the ways 28 and engage the splines 26. The length of the splines 26 is sufficient to maintain engagement with the lugs during the full actuation of the switch, preventing angular rotation of the plunger 30 relative to the barrel.

The open end portion additionally comprises a plurality of evenly spaced camming teeth 35. The camming teeth form a sawtooth annular ring on the end of the plunger. This embodiment utilizes eight camming teeth 35, four of which include end portions of the lugs. The camming teeth are asymmetrical as described below after other parts of the switch are described.

The ratchet mechanism of the switch comprises the spline ramps 27 and the ways 28 of the barrel, the lugs 34 on the plunger and spaced dogs 45 on the ratchet 40 and camming teeth 35 of the plunger and teeth 46 on ratchet 40.

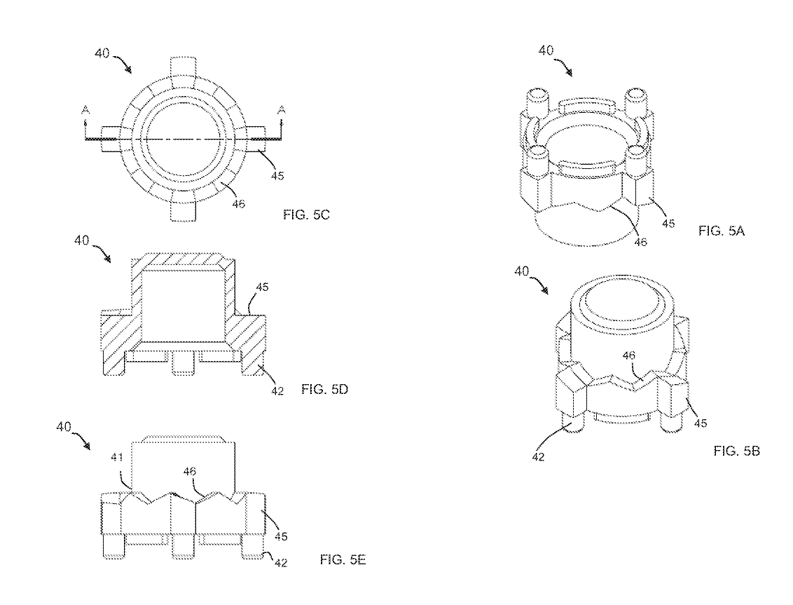

FIGS. 5A-5E show different views of the ratchet 40. Specifically, FIG. 5A shows a top perspective view of the ratchet, and FIG. 5B shows a bottom perspective view of the ratchet. FIG. 5C shows a top view of the ratchet, and FIG. 5D shows a cross-sectioned view of the ratchet in FIG. 5C along lines A-A. FIG. 5E shows a side view of the ratchet.

The ratchet 40 has a generally cylindrical lower portion with 4 post pins 42 extending outward. The ratchet has a plurality of circumferentially spaced dogs 45, with four dogs 45 being preferred in this embodiment to correspond to half the number of ways in the barrel. The dogs 45 are spaced 90° apart around the ratchet 40, projecting radially outwardly therefrom.

When the ratchet and plunger are inserted into the barrel, the dogs first engage the ramps 27 on the ends of the splines 26 and then enter the ways 28 along with the plunger. The splines 26 are of a length to permit disengagement from the dogs 45 during actuation of the switch, permitting angular rotation of the ratchet relative to the barrel and the plunger.

The portion 41 of the ratchet has a plurality of evenly spaced camming teeth 46, distributed around the exterior surface of the ratchet. The ratchet camming teeth face towards and cooperate with the plunger camming teeth 35. The camming teeth 46 in this embodiment of the ratchet may be symmetrical or asymmetrical as long as they allow the ratchet motion to follow the plunger camming teeth 35. FIG. 2F shows a top perspective view of the cover 2. FIG. 2G shows a bottom perspective view of the cover 2. FIG. 2H shows a top view of the cover 2, and FIG. 2I shows a cross-sectioned view of the cover in FIG. 2H along lines A-A. FIG. 2J shows a side view of the cover 2.

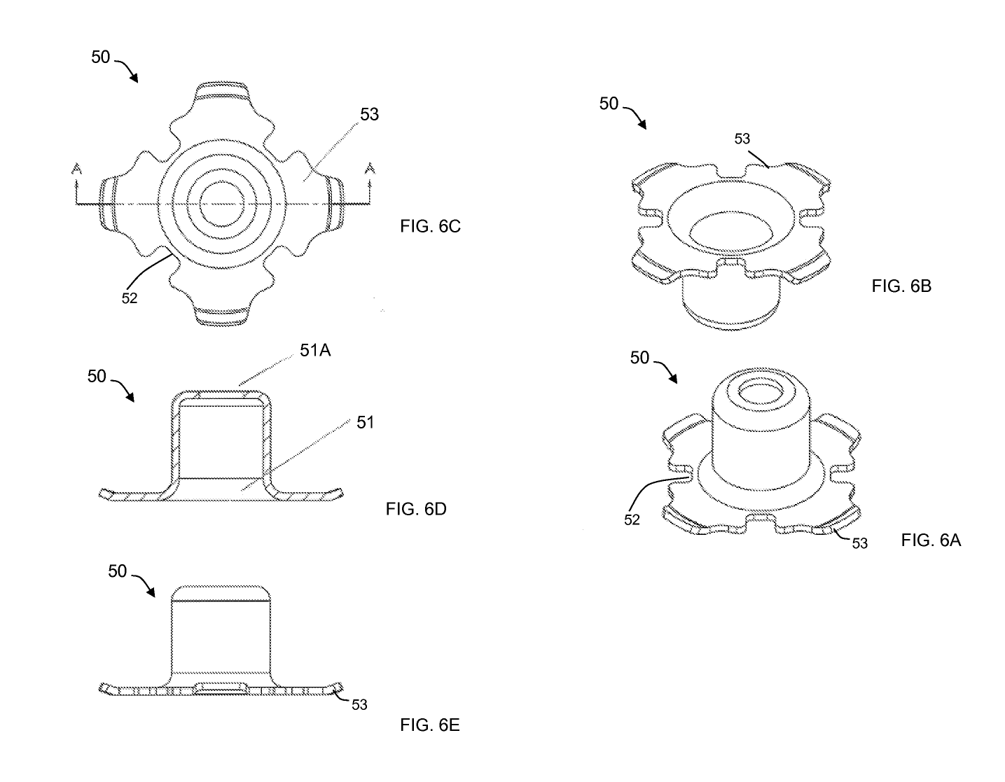

FIGS. 6A-6E show different views of the contact cup 50. Specifically, FIG. 6A shows a top perspective view of the contact cup, and FIG. 6B shows a bottom perspective view of the contact cup. FIG. 6C shows a bottom view of the contact cup, and FIG. 6D shows a cross-sectioned view of the contact cup in FIG. 6C along lines A-A. FIG. 6E shows a side view of the contact cup.

The contact cup 50 is made of a conductive material and is adapted for rotation to make and break electrical connections with a left terminal 75 and a right terminal 76 (FIG. 1). The contact cup is generally tubular in shape having one end opening 51 and the other end 51A partially closed. The open end of the contact cup has a circular flange 55 extending radially

outward from the circumference thereof. The partially open end has a circular opening 51 which provides a bearing surface for a central post stud 54 (FIG. 2F). The cup 50 includes contact tabs 53 that are designed in such a way that the tips of the tabs 53 are bent to allow for better electrical contact due to higher contact force with the contact portions of the terminals 75, 76.

During switch operation, the contact tabs 53 engage in a wiping contact with contact portions of the left and right terminals 75, 76. The contact tabs with curved edges on their tips, provide scraping motion on the contact portions of the terminals 75, 76 to cut through any oxidation that may form due to solder flux or other contamination.

In one embodiment (not shown), the contact cup may be additionally provided with a plurality of elongated longitudinal V-shaped grooves that engage ribs in the ratchet. This allows attaching the contact cup to the ratchet. In one embodiment, this mechanism is used to drive the contact, not to slide up or down within each other.

In another embodiment, there are no grooves on the contact cup. Slots 52 on the contact cup 50 engage pins (or posts) 42 on the ratchet, wherein posts 42 and slots 52 provide the ability for the ratchet, splines and plunger to rotate the contact cup. The contact tabs 53 are displaced approximately 22.5° from the ratchet dogs 45.

The switch cover 2 is provided with a plurality of recesses (holes) 13 in its conforming surface 8, in two substantially parallel rows on opposite sides of the central post stud 54. The recesses 13 mate with pin members 12 located in the mating surface 7 of the switch body 3 when the cover 2 and body 3 are assembled together. The cover and the body are preferably held together by means of an interference fit between the holes and the pin members. The combination of plastic material is selected to allow adequate push apart force.

An approximately circular recess or cavity 78 extends into the cover with its center aligned with the barrel axis 17 (FIG. 1). The central post stud 54 extends perpendicularly along the center of this recess or cavity. The cavity 78 is shaped to include a void area 78A (FIG. 2H) around the terminals 75 and 76, to control the migration of plastic material that may flow into the mechanical portion of the switch due to over-heating from a wave soldering process. The cavity 78 also includes a recess 87. Two terminal locating posts 65, 66 extend away from the recessed surface 7 of the body 3, to be received between two recessed surfaces 67, 68 located in the mating surface 8 of the cover 2.

The left and right terminals 75, 76 include portions 94, 95, and contact portions 88, 89. The terminals are mounted on the body and held in place by pins 12, 65 and 66. When the switch 1 is assembled, the portions 94, 95 remain exposed on the exterior of the switch 1 and are attachable to conventional electrical conductors to connect the switch 1 to an external electrical circuit. Recesses 116, 117 in the conforming surface 7 of the body 3 provide clearance for portions 94, 95 and 88, 89. Terminals 75 and 76 are symmetrical to reduce cost and assembly time. Terminals 75, 76 may also be asymmetrical.

In one embodiment of the invention, the non-metallic components of the switch are formed by molding such as injection molding. In one embodiment, the ratchet 40 and plunger 30 are made of a polyoxymethylene (POM) plastic, such as acetal, polyacetal, or polyformaldehyde, or other similar materials such as glass-filled thermoplastic material. In another embodiment, the ratchet 40 and plunger 30 may be made from nylon, usually unfilled nylon.

In one embodiment, utilizing POM plastics (such as acetal) for the ratchet and plunger provides high stiffness and rigidity up to about 160° Celsius, very low friction, high heat resistance, abrasion resistance, and improved dimensional stability to the ratchet and plunger.

In another embodiment, utilizing nylon for the ratchet and plunger provides high abrasion resistance, high resilience and durability, and melting points of about 255-270° Celsius to the ratchet and plunger.

In one embodiment, the non-metallic components of the switch, such as the cover 2 and the body 3, are made of a synthetic polymer material such as nylon to prevent material degradation and melting during wave soldering. Such a material has a higher melting temperature compared to other materials.

In one embodiment, utilizing glass-filled material (e.g., glass-filled nylon) for the cover and body provides for improved engagement of cover and body moldings 2 and 3 to each other, as compared to non-glass material. In one embodiment, the cover 2 and body 3 made out of glass-filled material increases the push apart force in the switch (i.e., the force necessary to separate the cover 2 and body 3 once assembled).

In one embodiment, the cover 2 and body 3 comprise nylon with about 25% glass-filled material (i.e., 25% glass-filled nylon). The plunger can also be made of glass-filled material (e.g., glass-filled nylon).

In one embodiment, about 20% glass-filled nylon is used for forming the body 3 and cover 2, while in another embodiment, about 13% glass-filled nylon is used for forming the body 3 and cover 2. In another embodiment, about 30% glass-filled nylon is used for forming the body 3 and cover 2. Other combinations of glass fill percentage may be used for the body 3 and cover 2. Further, other combinations of glass (or other higher melting temperature or heat resisting thermoplastic polyester resin semi-crystalline materials such as Valox™) may be used for the body 3 and cover 2.

In one embodiment, glycol or other lubricating material is used on the plastic components of the switch to allow the switch to pass high and low temperature test and durability tests.

In one embodiment, utilizing glass-filled nylon cover 2 and the body 3 provides advantages in manufacturing the cover 2 and the body 3 because unfilled nylon has a tendency to relax and lose rigidity over time. For example, if the cover 2 and the body 3 were manufactured with unfilled nylon and pin members 12 of the body 3 become initially engaged with the recesses 13 of the cover 2 in an assembled switch 1, the relaxation over time of the cover 2 and the body 3, and therefore the relaxation of recesses 13 and pin members 12, respectively, causes unintentional disengagements of pin members 12 from recesses 13, and the assembled switch 1 quickly becomes disassembled over time.

As such, utilizing glass-filled nylon instead of unfilled nylon in manufacturing the cover 2 and the body 3 prevents relaxation and loss of rigidity over time and promotes rigidity and structural integrity such that pin members 12 of the body 3 remain engaged with the recesses 13 of the cover 2 in an assembled switch 1 over said time.

Said glass-filled plastics increase structural and impact strength and rigidity, and according to embodiments of the invention are applicable to other injection molded electrical switches as well, wherein the present invention is not limited to the example pushbutton switches described herein.

It should be understood that the compositions of the non-metallic components of the switch are not limited to the example compositions of materials recited in the above embodiments, and other plastics that increase structural and impact strength and rigidity can also be utilized.

When assembled, the plunger 30 is inserted in the barrel 5, the ratchet 40 is positioned opposite and coaxial with the plunger, the contact cup 50 is inserted into the ratchet 40. The helical spring 107 is placed inside the contact cup. The spring 107 provides a continual force on the cup ears/tabs 53, biasing two of the tabs 53 one toward the left terminal and one towards the right terminal. The spring on the cup also biases the ratchet towards the plunger for engaging the ratchet teeth with the plunger teeth and also drives the rotary motion of the ratchet and cup.

The left and right contact portions 88, 89 (FIG. 1) contact tabs 53 in switch operation, and further the four tabs 53 on the contact cup are 90° apart. Thus, two of the adjacent tabs 53 on the contact cup must come into contact with terminal contact portions 88, 89 at the same time for the switch to be in the on position (circuit closed). When the plunger is pushed downward, the circuit will immediately break contact. At the same time the contact cup will rotate 22.5°. Next, in the upstroke of plunger as urged by the spring 107, the rotation of the cup moves another 22.5° (total rotation 45°), with the contact cup ears 53 then straddling left and right contact portions 88, 89 (without contacting the contact portions 88, 89) whereby the circuit is OFF (circuit open).

In the illustrated embodiment, the camming teeth 35 on the plunger are symmetrical to provide approximately 22.5° rotation of the ratchet and cup upon advance of the plunger toward the ratchet. Another 22.5° rotation of the ratchet and cup upon retraction of the plunger, e.g., when finger pressure is released occurs due to engagement of the ratchet lugs against the angled faces on the body splines.

During switch operation, when the plunger of the switch is not depressed, all of the contact tabs 53 are located circumferentially away from (i.e., not in contact with) either of the contact portions 88, 89 and the switch is OFF. The spring 107 is biasing the cup 5, the ratchet 40, towards the plunger 30 as far as it will go, engaging the ratchet dogs 45 within the ways in interior wall 16 of the barrel 5. The cup 50 also transfers the spring force to the ratchet 40 and transfers the force to the plunger 30 into the barrel 5 to its fullest extent, with the plunger lugs 34 engaging the walls of the splines adjacent to the ways 28 in interior wall of the barrel 5. The plunger camming teeth 35 and the ratchet camming teeth 46 are in partial engagement, being about 22.5° out of full alignment, apex to valley.

Switch actuation begins with a downstroke of the plunger 30. During the beginning and the middle of the downstroke, the plunger and the ratchet and the cup move down the barrel splines 26, compressing the spring. Near the end of the downstroke, the ratchet dogs 45 travel beyond the end of the splines 26 permitting partial rotation of the ratchet 40. The force of the spring 107 acting against the force of the downstroke causes the ratchet to rotate until the plunger camming teeth 35 and the ratchet camming teeth 46 are fully engaged. The amount of this rotation of the ratchet is 22.5° clockwise. The rotation of the ratchet is transferred to the contact cup 50 causing rotation of the contact tabs 53 about the lower portion of the stud 54. When the plunger is released, the ratchet rotates an additional 22.5° and thus two of the tabs 53 make contact with contact portions 88, 89, whereby the switch in ON.

As the plunger is depressed, the ratchet is also pushed downwardly against the spring. When the ratchet passes the ends of the splines, it is free to rotate and the sloping ramp of the leading face causes it to rotate to a position with the apex of the ratchet tooth in the valley between adjacent plunger teeth. In other words, the teeth on the ratchet and plunger are fully engaged even though the teeth do not have the same angles on the surfaces.

Equal angles on the surfaces of the teeth of the ratchet are not necessary. For example, the symmetrical ratchet teeth may have an included tip or apex angle of 90° and each face of the tooth has an angle of 45° to a plane normal to the axis. When the plunger retracts, the ratchet follows it upwardly as driven by the spring. When the ratchet dogs encounter the ramps on the ends of the splines, the ratchet cannot continue to follow the plunger in the same rotational orientation. Instead it is caused by force of the spring and engagement of the lugs and ramps to rotate. This rotation continues until the lugs can enter the next way between splines and the ratchet teeth move back into engagement with teeth on the plunger. The rotation of the ratchet is limited by the splines, however, and it comes to rest with the apex of a ratchet tooth at a location on the leading ramp face of the next plunger tooth.

The symmetrical teeth on the plunger and other parts of the assembly are positioned so that the location on the leading face where the apex of the ratchet tooth comes to rest is equidistant from each valley at the ends of that plunger tooth. In other words, about 22.5° from the valley at the end of the leading face and about 22.5° from the valley at the start of the previous trailing face. This can be accomplished with any number of angular relationships between the lugs, dogs, camming teeth and terminal contacts.

An example of the way the plunger lugs, ratchet dogs, splines, end ramps on the splines and teeth on the plunger and ratchet interact to cause rotation of the ratchet upon depressing the plunger is described generally in U.S. Pat. No. 6,191,376.

Although described with four electrical contact tabs, four ratchet dogs, eight ratchet teeth, eight plunger teeth, four plunger lugs and eight splines, other numbers may be employed in other embodiments of pushbutton switch. The number of teeth on the plunger and ratchet is 360°/x where x is the circumferential angle of one full tooth (in this case x=45° and the number of teeth n is eight). In other embodiments, the number of teeth n may be three or five, for example, when greater or less angular rotation is desired for each depression of the plunger. The angles and numbers of splines, etc., change commensurately. If one desires a switch with a cycle of ON upon one stroke of the plunger and OFF on the next stroke, the number of splines is made equal to the number of tabs and the terminal contact portions are located accordingly. A similar arrangement can be used where successive strokes of the plunger alternate contact between the left and right terminals.

Generally speaking, the switch is made easier to operate in terms of push force required on the plunger than prior switches having a structure as described above, by increasing the angle of the ramps 27 form the ends of the splines 26. In one example, the ramps have an angle of about 55° from the sides of the splines. Higher than 55° angle may be used.

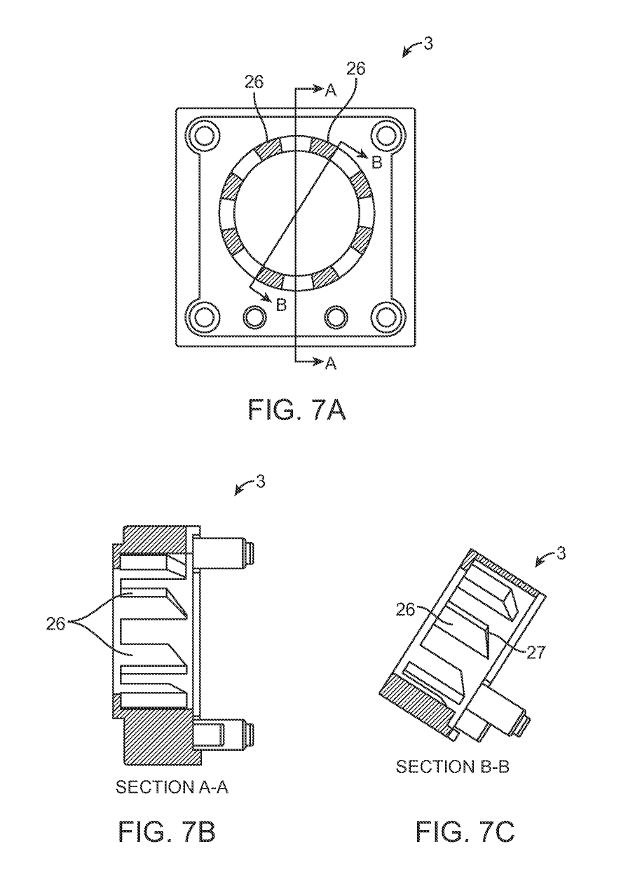

FIGS. 7A-7C show different views of the body 3 and splines 26 of the switch 1. Specifically, FIG. 7A shows a bottom view of the body, FIG. 7B shows a cross-sectioned view of the body in FIG. 7A along lines A-A, and FIG. 7C shows a cross-sectioned view of the body in FIG. 7A along lines B-B.

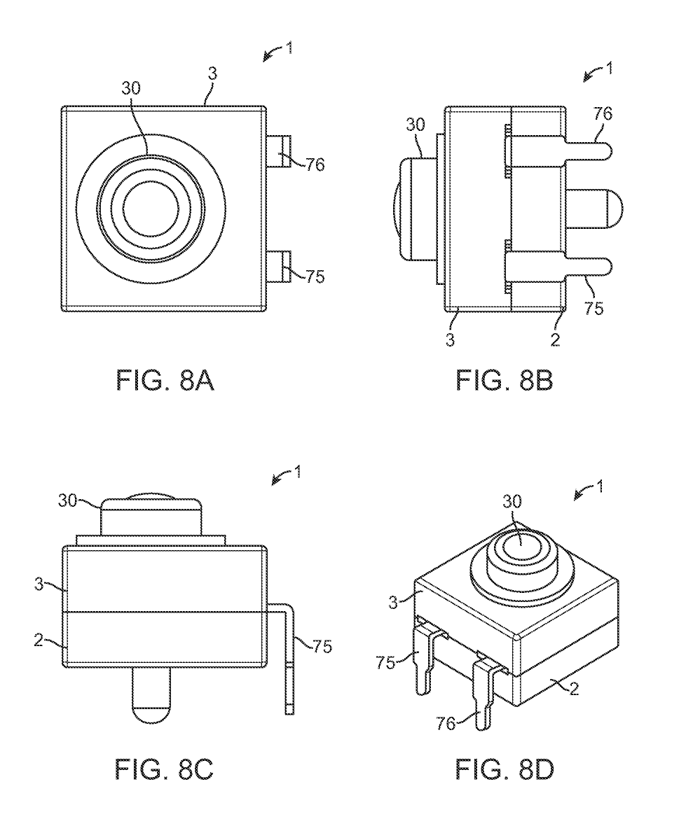

FIGS. 8A-8D show various views of an embodiment the switch 1, in assembled form. Specifically, FIG. 8A shows a top view of the switch, FIG. 8B shows a side view of the switch 1, FIG. 8C shows another side view of the switch 1, and FIG. 8D shows a perspective view of the switch 1.

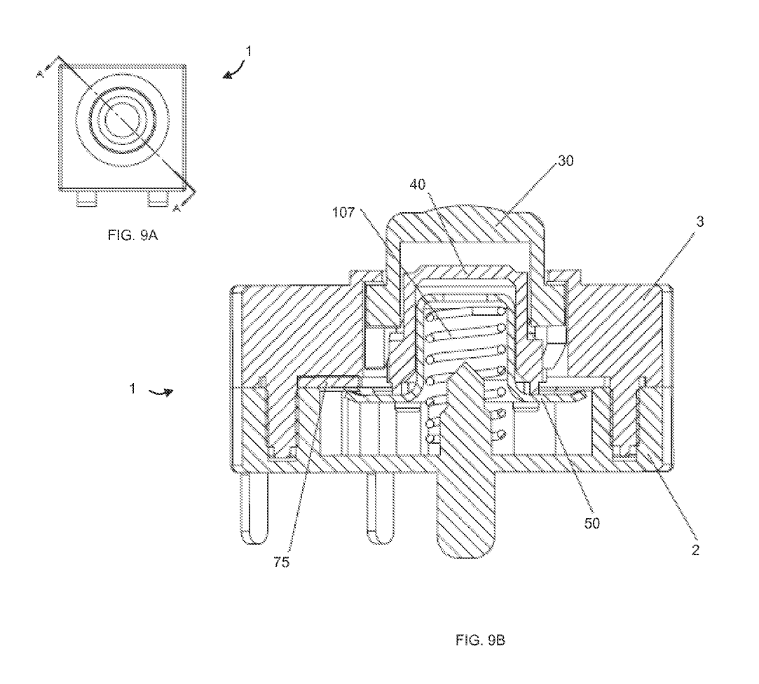

FIGS. 9A-9B show further views of the switch of FIG. 1, in assembled form. Specifically, FIG. 9A shows a top view of the assembled switch 1, and FIG. 9B shows a cross-sectioned view of the switch in FIG. 9A along lines A-A, wherein internal components of the switch 1 within the housing, formed by body 3 and cover 2, are illustrated.

Table 1 below provides example construction material and example specifications, for an embodiment of the switch 1.

```
TABLE 1
1. MATERIAL
    PLASTIC-(Ratchet, Plunger)-ACETAL
    PLASTIC-(Body, Cover)-NYLON
    TERMINALS-MTL: PHOSPHOR BRONZE OR BRASS
    ROTARY CUP-MTL: BRASS
    PLATING ON TERMINALS AND ROTARY CUP:
        .0002 SILVER PLATE, BRIGHT TO SEMI BRIGHT, PER
        QQ-S-365 OVER .00005 NICKLE PER QQ-N-290, CLASS 2
    SPRING-MUSIC WIRE
2. ELECTRICAL SPECIFICATION
    Switch load to be 150 MA at 13 V
    Switch contact resistance:
      less that 100 MV drop before and after testing
3. DURABILITY CYCLING
    15,000 cycles at room temperature
        3,750 cycles at +23 C.
        3,750 cycles at −40 C.
        3,750 cycles at +23 C.
        3,750 cycles at +105 C.
    A cycle rate shall be 6 to 12 cycles per minute.
      One cycle is “on” then “off”.
    Actuation force-2N ± .5N
```

Further, generally speaking, the switch is made quieter than prior switches having a structure as described above, by increasing the angle of the slope of the splines. The angle of the driving face of the body spline slope teeth is considered as the angle from a normal to the longitudinal direction of the plunger. Stated otherwise, it is the complement of the angle between the driving face and the longitudinal direction.

The minimum angle of the driving face is such that the tangent of the angle is more than the coefficient of friction between the ratchet teeth and the body spline slope teeth plus the coefficients of friction between other mechanisms moved by the ratchet, for example, friction between electrical contacts in the switch. Preferably, the principal sources of friction are considered to determine a minimum angle for the driving face, and then a margin of safety is added to account for additional friction not readily calculated and for increases in friction over the life of the mechanism.

An example of the way the plunger lugs, ratchet dogs, splines, end ramps on the splines and teeth on the plunger and ratchet interact to cause rotation of the ratchet upon depressing the plunger is described generally in U.S. Pat. No. 6,191,376 and in U.S. Pat. No. 6,621,028, both incorporated herein by reference.

As a matter of convenience in the description, a spline at a selected angle is recited on the body and a plurality of teeth is recited on the ratchet. It should be understood that the converse with one tooth on the ratchet and a plurality of splines on the body is equivalent and included within the scope of the claims. Similarly, the low angle on the tooth (or teeth) on the plunger to make the switch quieter could also be on the ratchet tooth (or teeth) and should be considered equivalent. The “driving face” of the spline could then be considered as a “driven face”. To recite all of these equivalent variations in separate claims would unduly multiply the number of claims without changing the scope of coverage. It so happens that in the embodiment described, the plunger and ratchet teeth have different shapes. These shapes could be more similar, so that the low angle is present on both sets of teeth. Other structural equivalencies should be recognized including the spline angle.

In the description above, numerous specific details are set forth. However, it is understood that embodiments of the invention may be practiced without these specific details. For example, well-known equivalent components and elements may be substituted in place of those described herein, and similarly, well-known equivalent techniques may be substituted in place of the particular techniques disclosed. In other instances, well-known structures and techniques have not been shown in detail to avoid obscuring the understanding of this description.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or an element, that does not mean there is only one of the element. If the specification or claims refer to “an additional” element, that does not preclude there being more than one of the additional element.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A pushbutton switch, comprising:
a body including a barrel;
a plunger longitudinally movable in the barrel;
a ratchet coaxial with the plunger including a plurality of longitudinally extending camming teeth; and
at least one longitudinally extending camming tooth on the plunger for engagement with the camming teeth on the ratchet;
wherein the body comprises a synthetic polymer material.

2. The switch of claim 1, wherein:
the cover comprises synthetic polymer material.

3. The switch of claim 1, wherein:
the ratchet comprises a polyoxymethylene (POM) plastic material.

4. The switch of claim 1, wherein:
the plunger comprises a polyoxymethylene (POM) plastic material

5. The switch of claim 1, wherein:
the body comprises a glass-filled material.

6. The switch of claim 1, wherein the body comprises from about 10% to about 30% glass-filled synthetic polymer material.

7. The switch of claim 1, wherein:
the cover comprises a glass-filled material.

8. The switch of claim 1, wherein the cover comprises from about 10% to about 30% glass-filled synthetic polymer material.

9. The switch of claim 1, wherein lubricants are deposited on the plunger and the ratchet.

10. The switch of claim 1, wherein:
the plunger tooth includes a driving face having an angle from a normal to the longitudinal direction of the plunger.
